(19) United States
(12) Patent Application Publication
(10) Pub. No.: US 2026/0159049 A1
(43) Pub. Date: Jun. 11, 2026

(54) AUXILIARY TRAILER BRAKE CONTROLLER

(71) Applicant: Matthew J. Terlau, Arlington, WA (US)

(72) Inventor: Matthew J. Terlau, Arlington, WA (US)

(21) Appl. No.: 19/414,117

(22) Filed: Dec. 9, 2025

Related U.S. Application Data
(60) Provisional application No. 63/729,842, filed on Dec. 9, 2024.

(51) Int. Cl. B60T 8/17; B60T 7/08

(52) U.S. Cl. CPC B60T 8/17; B60T 7/08; B60T 2201/06

(57) ABSTRACT

A brake controller disposable in the electrical communication circuit between a tow vehicle and a trailer. A brake controller is operable to permit a user to control a trailer brake from exterior to the tow vehicle. The brake controller includes an input to receive a user's command to apply a brake, and is operable to apply the trailer brake responsive to the user's command input.

### RELATED APPLICATIONS

This utility patent application claims the benefit under 35 U.S.C. 119(e) of the filing date of Provisional Patent Application Ser. No. 63/729,842, filed Dec. 9, 2024, and titled “AUXILIARY TRAILER BRAKE CONTROLLER”.

### BACKGROUND

### Field of the Invention

This invention relates to devices configured to actuate brakes of a towable trailer.

### State of the Art

A trailer attached to a tow vehicle exerts a mechanical load on the vehicle when the vehicle is parked and not moving. Whether the vehicle is parked on a slight incline, or a trailer is being loaded, the mass of the trailer, or shifting of the mass induces mechanical loading of the vehicle's drivetrain and brakes. This causes wear and damage to the transmission, differential, and other components.

It is conceivable that an increasingly heavier loaded trailer might eventually overcome the parking brake force provided by a parked vehicle. A consequence is that the loaded trailer may tow the attached vehicle on an unexpected ride.

Many large industrial trailers incorporate an independent braking system on their axels to provide extra braking capability for the vehicle in transit. Trailer brake control is conventionally achieved with an electronic controller located inside the passenger compartment of the vehicle. When the vehicle's brakes are activated, the controller sends an electrical activation signal to the trailer brakes that are activated in parallel with the vehicle's brakes.

Typically, for industrial (or heavy duty consumer) trailers, the electrical signal for brake control is transmitted through a removable plug that connects the trailer wiring harness to the tow vehicle. This plug transmits electrical signals from the tow vehicle to the trailer brakes and the trailer lights.

### BRIEF DESCRIPTION OF THE DRAWINGS

In the drawings, which illustrate what is currently regarded as the best modes for carrying out the invention, and which carry notations that constitute a portion of this disclosure:

FIG. 1 is an exploded isometric assembly view of a first preferred embodiment structured according to certain aspects of the instant invention;

FIG. 2 is a top view in elevation of the embodiment in FIG. 1;

FIG. 3 is a bottom isometric view of the embodiment in FIG. 1;

FIG. 4 is a top isometric view of the embodiment in FIG. 1;

FIG. 5 is another top isometric view of the embodiment in FIG. 1;

FIG. 6 is a close-up view of the embodiment in FIG. 1;

FIG. 7 is a front view in perspective of an adapter for disposal between a conventional (e.g., 7-pin) male trailer plug and its cooperating female socket;

FIG. 8 is a front view in perspective if the embodiment in FIG. 7, from the other side;

FIG. 9 is a rear view in perspective of the embodiment in FIG. 7;

FIG. 10 is a view in perspective of an adapter for disposal between an alternative male trailer plug and a conventional (e.g., 7-pin) female socket;

FIG. 11 is a view in perspective if the embodiment in FIG. 10, from the other end; and

FIG. 12 illustrates a variety of perspective views of an alternative embodiment.

### DETAILED DESCRIPTION OF THE ILLUSTRATED EMBODIMENTS

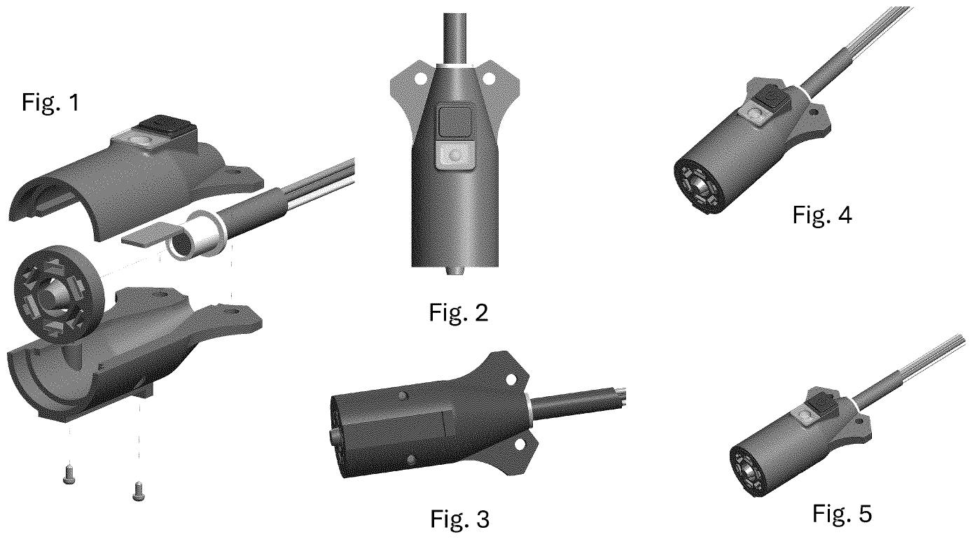

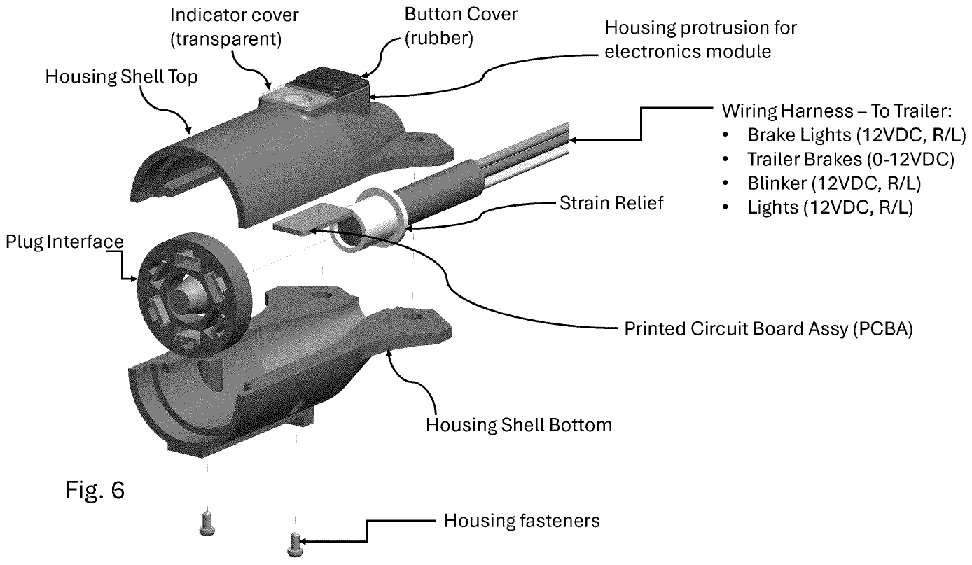

FIGS. 1-6 illustrate a first preferred embodiment according to certain aspect of the instant invention. As best illustrated in FIG. 6, this embodiment may be configured as a replacement for a conventional trailer harness 7-pin male plug. This male plug provides a conventional interface between a pigtail from a trailer and a commercially available female trailer socket that is typically disposed on, or near, the rear bumper of a tow vehicle. While a 7-pin trailer circuit is illustrated, alternative arrangements are also workable.

The embodiment in FIGS. 1-6 includes a control assembly, such as the printed circuit board assembly, disposed operably in circuit with the wiring harness and an activation element associated with a housing of the plug. An operable activation element includes a switch associated with the indicator cover. A user may operate the activation element to engage the trailer brakes on demand, from a location outside of the tow vehicle.

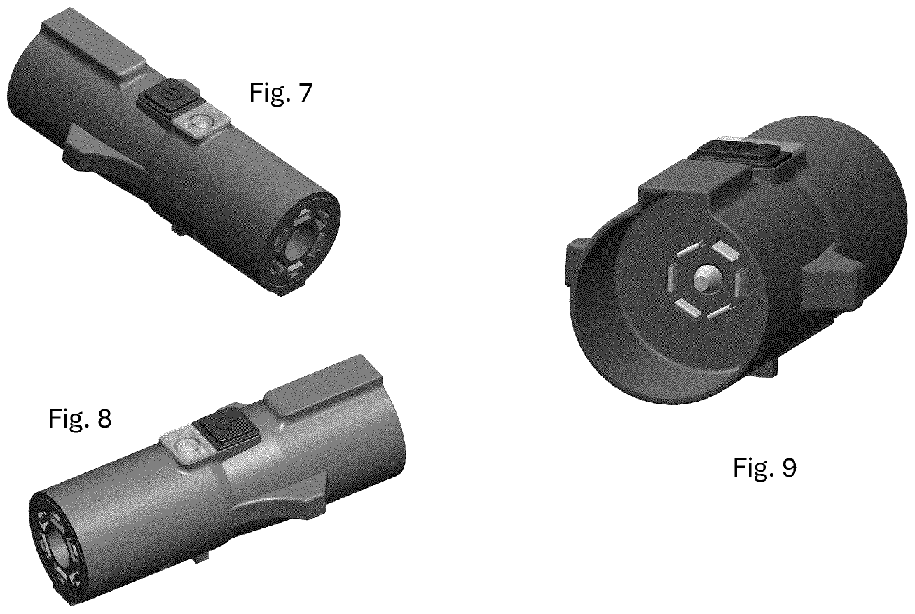

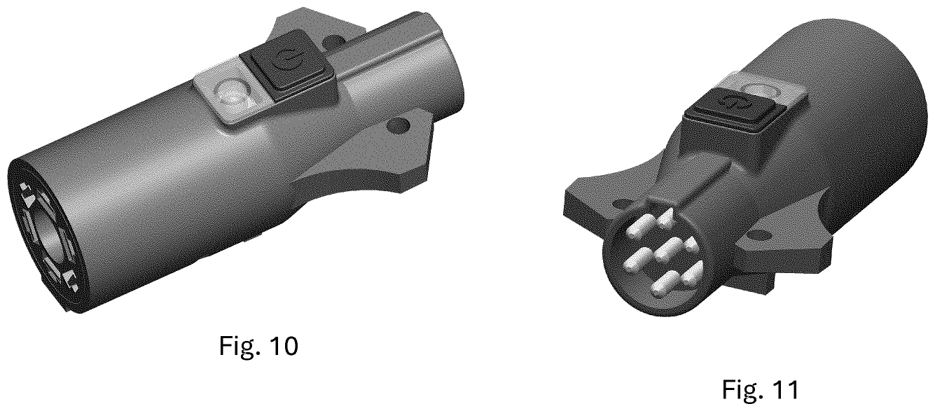

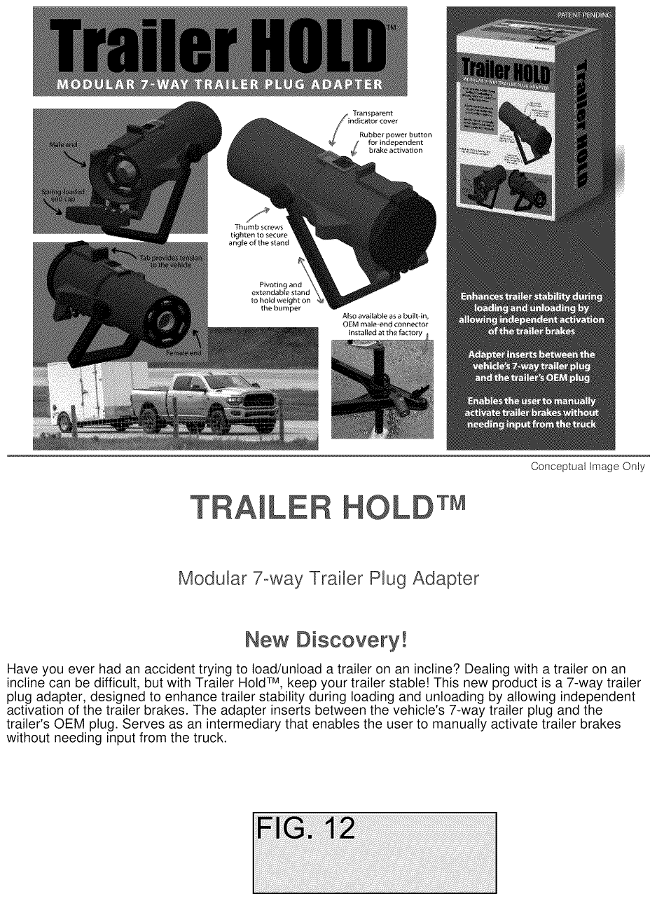

In an alternative embodiment within contemplation, (see FIGS. 7 through 9) the invention may be configured as a female-male adapter between a conventional male pigtail plug associated with a trailer and a conventional female socket associated with a tow vehicle. The adapter in this embodiment carries the intelligent circuit assembly and activation element to permit manual application of trailer brakes from a convenient location external from the vehicle. It is contemplated that embodiments of the invention may adapt various alternative trailer plugs to a preferred arrangement, such as illustrated in FIGS. 10 and 11.

Sometimes, other devices, inputs, outputs, and the like may be provided to enhance device functionality. For non-limiting examples, one or more display element may be included to indicate condition of operation, such as “brakes engaged” or “brakes not engaged”.

It is within contemplation that the functionality of the instant invention may be integrated into an OEM delivered (built-in) arrangement in a vehicle. The desired functionality could be replicated with in-cab, computer programming to integrate a trailer brake hold feature on new vehicles with computer programming capabilities. The desired functionality could also be provided via mechanical operation on new vehicles not equipped with programming capabilities via a “trailer hold button” integrated into factory trailer brake module/switch on dash or console, or near a front or rear bumper. An alternative wired or wireless (and therefore portable) remote brake control assembly may be provided in certain cases.

In one nonexclusive example of use of a device such as illustrated in FIGS. 1-6, when the vehicle is parked, a user standing at the tow vehicle's bumper area can push a button on the male plug housing, which manually activates the trailer brakes. Desirably, the control assembly is constructed such that a subsequent brake signal provided from the truck (or from some other input, such as vehicle motion, subsequent manual activation or button push, or other desired control over-ride signal) disengages the trailer brakes.

The initial manual and external activation of the trailer brakes when the vehicle is parked reduces the mechanical load that the trailer and its mass exerts on the vehicle, thereby preventing undesired wear/damage to the vehicles drivetrain and braking system(s). The manual brake activation from an embodiment may be retracted by a subsequent manually applied input. However, it is desirable to provide a secondary electrical circuit acting redundantly, to provide a backup to ensure that any time the vehicle is out of park, or moving, the manually applied, external-to-the-vehicle, brake activation is overridden.

It is envisioned that embodiments according to certain aspects of the invention may be constructed to provide security/Anti-theft devices. Such a device could serve as a temporary anti-theft device for all trailers with electric brake, or electric over hydraulic brake systems. One such device may include a keypad, key fob, or wireless controller to activate and de-activate the brake control module, secure steel battery housing, electric brake activation module, a charge controller with solar and direct 120v ac input for continuous power or trickle charging may also sometimes be included. This device would provide trailer manufacturers and owners the ability to temporary lock the trailer brakes for a certain period of time to prevent trailer theft or enhance loading/unloading stability when not connected to a vehicle. An operable anti-theft device may include a stand-alone power source and security measures to activate/de-activate the unit.

What is claimed is:

1. In a trailer control system of the type that removably couples a trailer in electrical communication with a tow vehicle, the improvement comprising:
a controller comprising an input receiver, disposed in a path of communication between the tow vehicle and the trailer, to receive a brake command from a user, who is outside the tow vehicle, the controller being configured and arranged to actuate a brake system of the trailer responsive to the brake command.
